(19) United States
(12) Patent Application Publication
(10) Pub. No.: US 2017/0105578 A1
(43) Pub. Date: Apr. 20, 2017

(54) FOOD PROCESSOR SPIRAL CUTTING ATTACHMENT

(71) Applicant: Spectrum Brands, Inc., Middleton, WI (US)

(72) Inventor: Joseph V. Krebs, Madison, WI (US)

(21) Appl. No.: 15/297,958

(22) Filed: Oct. 19, 2016

Related U.S. Application Data
(60) Provisional application No. 62/243,791, filed on Oct. 20, 2015.

(51) Int. Cl. A47J 43/07; B26D 3/11

(52) U.S. Cl. CPC A47J 43/0722; B26D 3/11

(57) ABSTRACT

The invention described herein is directed to a spiral cutting attachment and more generally to a food cutting assembly that is configured to fit inside most standard food processing machines to not only substitute standalone blades but also to provide a catch bowl for the processed or cut food that is easily removable from the main food processing bowl or jar. In one particular embodiment, the food cutting assembly is configured to generate spiral or helical food from vegetables.

### CLAIM OF PRIORITY

This application claims priority to and the benefit of a U.S. Provisional application with Ser. No. 62/243,791, filed on Oct. 20, 2015, which is incorporated herein by reference in its entirety.

### FIELD OF THE INVENTION

The invention described herein relates to food processing devices and to mechanical and handheld spiral cutting devices.

### BACKGROUND

There are food processing apparatus of the type having a working bowl or jug or jar with a motor-driven shaft projecting vertically upwards through the bottom of the bowl. Various selected rotary tools can be engaged on and driven by the shaft for performing many different food processing operations as may be desired by the user. A detachable cover or lid is usually secured over the top of the bowl during use. The cover typically includes a chute or feed tube which has a mouth that opens downwardly through the cover into the top of the bowl. The food items to be prepared or processed may be placed in the chute and then are manually pushed down through the top chute into the bowl by means of a removable pusher or plunger member which is adapted to slide down into the inlet chute in the manner of a plunger. For further information and examples about this type of food preparing apparatus reference is made to U.S. Pat. Nos. 5,921,485 and 7,159,808.

A number of food processing units typically come with interchangeable rotary tools which may be used in the food processor including slicing discs, shredding discs, grating discs, etc. which have a disc-like cutting tool member formed of sheet metal, preferably stainless steel, or plastic, with one or more cutting elements projecting above the upper surface of the cutting disc member. These various disc-like cutting members are generally positioned in the top of the bowl near the lower surface of the cover where they can cut, slice, shred, or grate the food items entering downwardly from the chute into the top of the bowl. For the purpose of positioning the cutting discs at or near the top of the bowl, such a rotary tool may include a relatively long hollow hub or shaft extending relatively far down into the bowl, depending upon the height of the motor-driven tool shaft in the bowl. This hollow shaft slides vertically down around the upper end of the tool shaft. In order to provide a driving connection between the shaft and this hollow hub or rod, the shaft is formed with driving coupling means, such as a flat face, keyway or spline, and the hollow hub has complementary coupling means, such as internal lugs, keys, or grooves for engaging the shaft. Thus, each of the various cutting disc members can be engaged quickly and easily with the shaft in a positive driving relationship and also can be removed quickly and conveniently to be replaced by another.

One type of food preparation is the cutting of vegetables, such as a tomato into slices or onions in to slices or into a diced form. Examples of slicing or grating discs of the prior art are shown in U.S. Pat. No. 4,877,191 which has a horizontal blade spaced above the plane of the disc and is well suited for slicing a cucumber, carrot or potato into slices of uniform thickness. However, one of the challenges has been to cut these vegetables into spiral or helical forms with the use of an automatic food processor. Those devices that do provide for automatic spiral cutting obligate the consumer to invest in another expensive appliance because this one appliance is dedicated to only one form of cutting. The more inexpensive options provided to date have been mechanical or hand-cranked spiraling cutters but these also take up counter or shelf space, are slow and require additional time for cleaning. It would therefore be advantageous to have an apparatus that would provide for automatic spiraling or helical cutting of vegetables using a food processor and motor configuration.

### SUMMARY

Spiral or helical cutters (Spiralizers) are becoming more popular in the market, however none are motorized. The invention described herein discloses a simple motorized solution in a familiar food processor format by providing a spiral cutting attachment and a food cutting assembly. The food cutting assembly is not only configured to fit inside most standard food processing machines so as to be a substitute for standalone blades but also to provide a catch bowl for the processed or cut food that is easily removable from the main food processing bowl or jar. In one particular embodiment, the food cutting assembly is configured to generate spiral or helical food from vegetables. An advantage to this form factor is that the food cutting assembly can simply be put into the dishwasher for cleaning while the rest of the food processor remains virtually clean. Once the user is done with the food cutting assembly, it can also be easily stored away with the other cutting blades of the food processor.

In one example embodiment, a food processing device is provided with a motor, base bowl or jar, catch bowl and blade-integrated lid and a food processor lid. The combination of the blade assembly and the lid for the catch bowl allow for spiral cutting of foodstuffs. The base bowl lid features a chute assembly with a main center chute for spiral cutting and a radial (or laterally disposed) chute for slicing and shredding. In this example embodiment, a center blade apparatus with an offset shaft allows for complete spiral cutting. The main center chute in the lid aligns with the center of this blade-integrated lid of the catch bowl. A pusher for the center chute keeps the food item (such as a cucumber or carrot) from spinning as it is inserted into the center chute. The blade-integrated lid is equipped with a slicing blade spaced off of the surface of the blade to cut. In related embodiments, additional blade-integrated lids that are potentially removable are provided for creating noodles or spiral cut julienne, depending on how coarse the user wants the cut vegetable to be. The same blade can be utilized with the outer chutes which will cut, juilenne-cut, shred, grate or dice the food or vegetable inserted into the processor.

In one example embodiment, there is provided a food processing assembly including a base bowl and a lid, the lid further including a chute assembly having a center chute extending from an outer surface of the lid, the base bowl and lid adapted to be located on a motor driven base having a drive shaft extending up from the base and into a center tube in the base bowl. The food processing assembly also includes a catch bowl located concentric and slideably engaged with the base bowl, the catch bowl including a drive shaft engaging center tube protruding upwardly from a catch bowl floor to engage the drive shaft and allow for rotation of the catch bowl relative the base bowl, the catch bowl having generally perpendicular sidewalls extending up from the catch bowl floor and terminating at an upper rim of the catch bowl. The food processing assembly further includes a blade-integrated lid configured to mate with the catch bowl at the upper rim and to be removably securable to the catch bowl, the blade-integrated lid including a blade assembly on a blade-integrated lid surface and an opening adjacent the blade assembly that is open to an interior of the catch bowl; wherein the catch bowl and blade-integrated lid operate as a food cutting assembly within the base bowl, as the catch bowl and lid are being rotated at a continuous speed by the drive shaft within the base bowl, to cut food received from the center chute with the blade assembly and direct the cut food into the catch bowl through the opening.

In another example embodiment, there is provided a food cutting assembly adapted for use with a food processing apparatus having a base bowl, a lid and a center chute extending from an outer surface of the lid and a motor driven drive shaft, the food cutting assembly including a catch bowl configured to be concentric and slideably engaged with the base bowl, the catch bowl including a drive shaft engaging center tube protruding upwardly from a catch bowl floor to engage the drive shaft and allow for rotation of the catch bowl relative the base bowl, the catch bowl having generally perpendicular sidewalls extending up from the catch bowl floor and terminating at an upper rim of the catch bowl. The food cutting assembly further includes a blade-integrated lid configured to mate with the catch bowl at the upper rim and to be removably securable to the catch bowl, the blade-integrated lid including a blade assembly on a blade-integrated lid surface and an opening adjacent the blade assembly that is open to an interior of the catch bowl; wherein the catch bowl and blade-integrated lid cut food received from the center chute with the blade assembly and direct the cut food into the catch bowl through the opening as the catch bowl and lid are being rotated at a continuous speed by the drive shaft.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DESCRIPTION OF THE DRAWINGS

Other important objects and advantages of the invention will be apparent from the following detailed description of the invention taken in connection with the accompanying drawings in which:

FIGS. 1A-1C illustrate perspective, rear and bottom views of an improved food processing assembly including a base bowl, a base lid and a chute assembly in accordance with the invention;

FIGS. 2A-2C illustrate right side, rear and left side cutaway views of a food cutting assembly inside the base bowl and lid in accordance with the invention;

FIGS. 3A-3B illustrate partial cross-sectional views of a catch bowl and a catch lid with a blade assembly inside the food processing assembly of FIG. 1 in accordance with the invention; and

FIG. 4 is a right side cutaway perspective plan view of the food cutting assembly of FIG. 2A in accordance with the invention.

### DETAILED DESCRIPTION OF THE INVENTION

The following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The various embodiments of the invention are directed to a spiral cutting attachment and more generally to a food cutting assembly that is configured to fit inside most standard food processing machines to not only substitute standalone blades but also to provide a catch bowl for the processed or cut food that is easily removable from the main food processing bowl or jar. In one particular embodiment, the food cutting assembly is configured to generate spiral or helical food from vegetables.

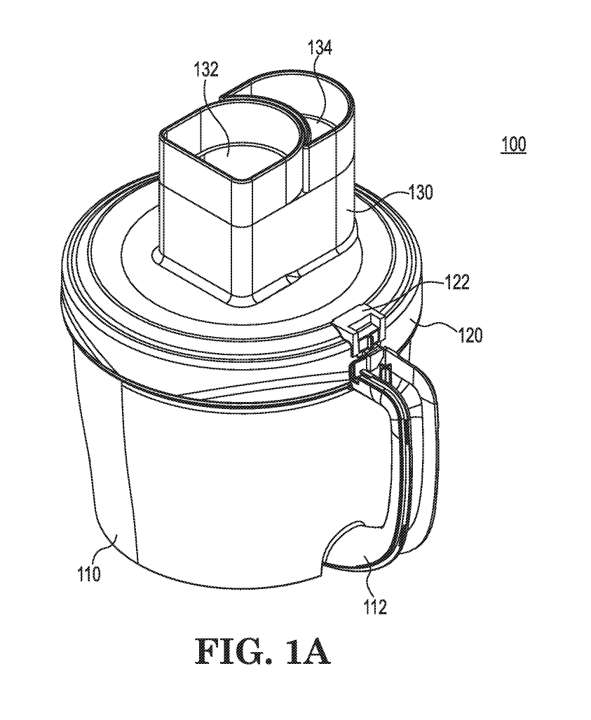

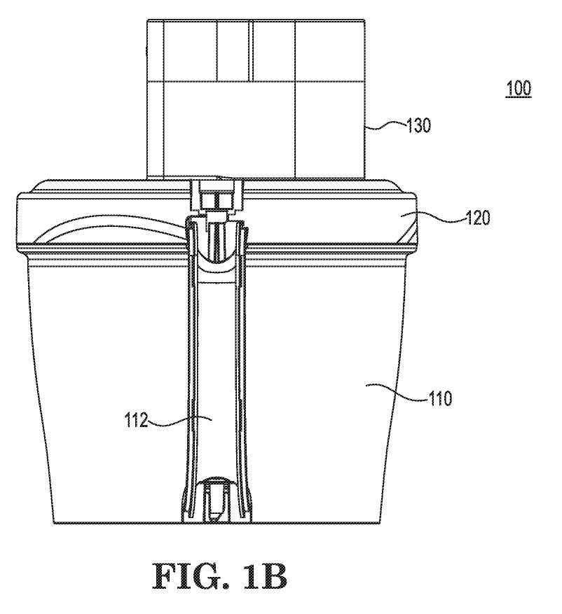

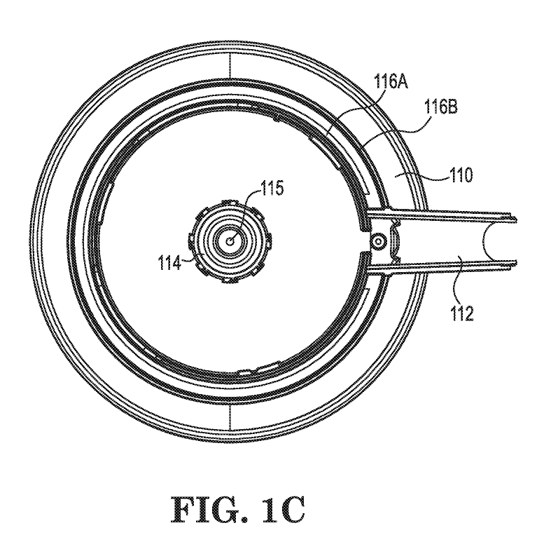

Referring now to the figures, FIGS. 1A-1C illustrate perspective, rear and bottom views of an improved food processing assembly 100 including a base bowl 110, a base lid 120 that attaches to base bowl 110 and a chute assembly 130 that is located on base lid 120. In particular, food processor assembly 100 has a generally a bowl or barrel-shaped base bowl 110 with a handle 112, which is designed to be located on a standard food processing motorized base. The motor is preferably a conventional electric motor and is operatively engaged with and rotates an upwardly extending drive shaft. Base lid 120 cantilevers onto base bowl 110 via latch 122 or can be twisted onto the base bowl. Chute assembly 130, in this example embodiment, includes a main, center chute 132 and a radial or lateral chute 134 and a pusher (not shown) for pushing a food item into the processing assembly 100. FIG. 1C illustrates the bottom of base bowl 110 along with inner and outer rims 116A and 116B that typically mate with and lock onto the motorized base of a food processing machine. Base bowl 110 also includes a sleeve 114 and a hole 115 that allows base bowl 110 to be placed over the drive shaft of the food processor. In this example embodiment, base bowl 110 and lid 120 are made of transparent or translucent plastic but can also be made of glass, such as Pyrex® brand of glass, or ceramic.

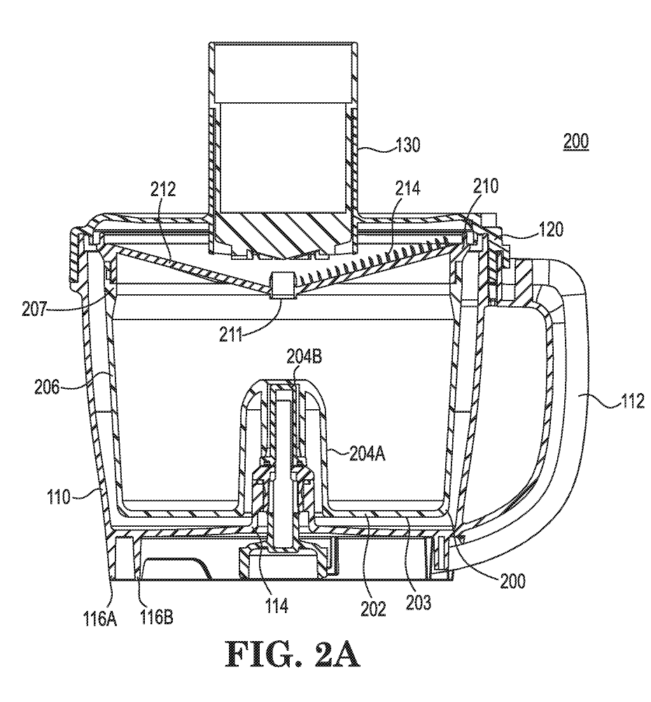

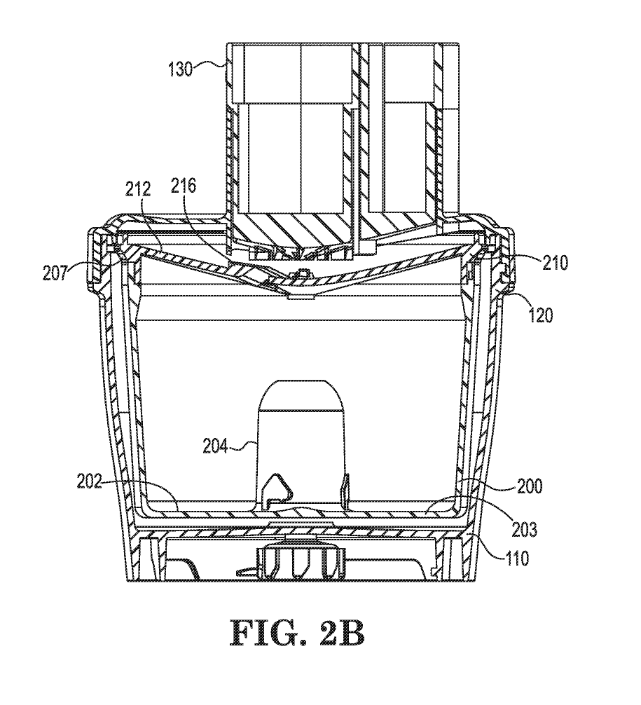

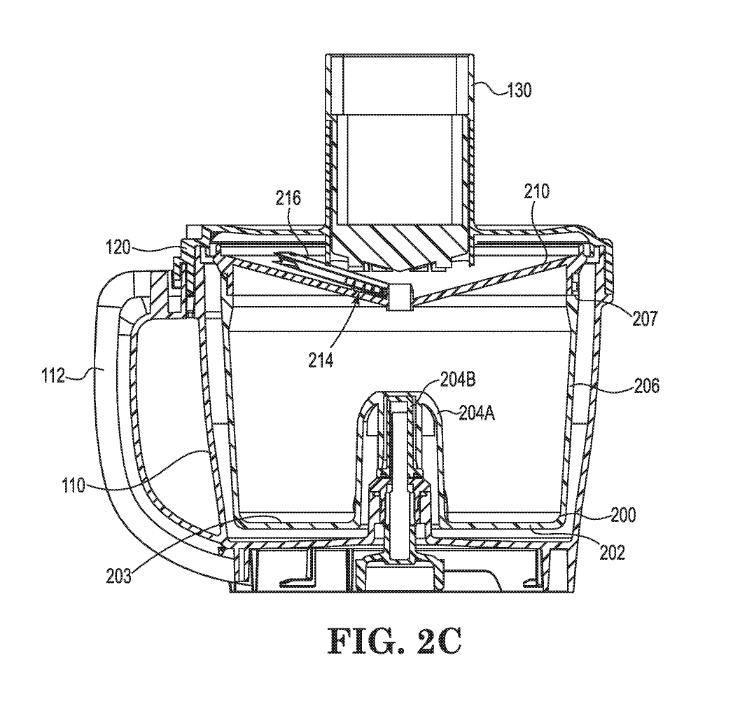

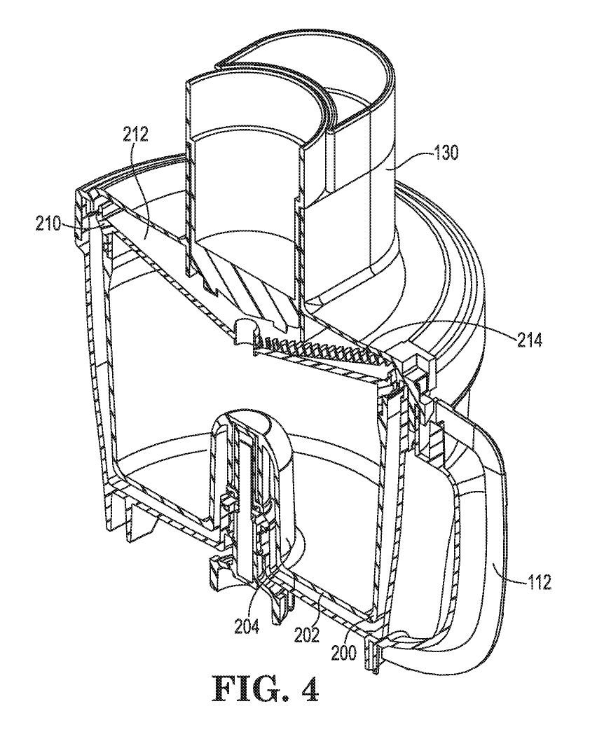

Referring now to FIGS. 2A-2C, there is illustrated right side, rear and left side cutaway views of a food cutting assembly 200 inside base bowl 110 and lid 120 in accordance with an example embodiment of the invention. Relatedly, FIG. 4 illustrates a right side cutaway perspective plan view of the food cutting assembly of FIG. 2A in accordance with the invention. In this example embodiment, food cutting assembly 200 includes a catch bowl 202, which is concentrically located and removably securable within base bowl 110 and base lid 120, having a catch bowl floor 203, a drive shaft engaging member 204A with a cylinder or sleeve 204B disposed on floor 203, sidewalls 206 adjacent to floor 203 and an upper rim 207 at the top of sidewalls 206. In this example embodiment, sleeve 204B engages with and frictionally fits a drive shaft of the motor in a food processing base. Food cutting assembly 200 further includes a blade-integrated lid 210 disposed on upper rim 207 that is removably engaged with and secured to catch bowl 202. Blade-integrated lid 210 can be secured to catch bowl 202 by various mechanisms including, but not limited to, a twist on or threaded on configuration to catch bowl 202 or via snap-on or by frictional fit onto catch bowl 202. Blade-integrated lid 210 includes a blade assembly 216, on a blade-integrated lid surface 212, along with an opening 217 that is adjacent blade assembly 216 which is open to an interior of catch bowl 202. In one example embodiment, lid 210 includes a loop handle (not shown) that is attached in a swivel manner at opposite edges of lid 210 to help put lid 210 onto catch bowl 202 (the loop handle then lays down when not in use). The loop handle attached thereto also facilitates securing the blade-integrated lid to the catch bowl and assists in lifting the food cutting assembly from the base bowl.

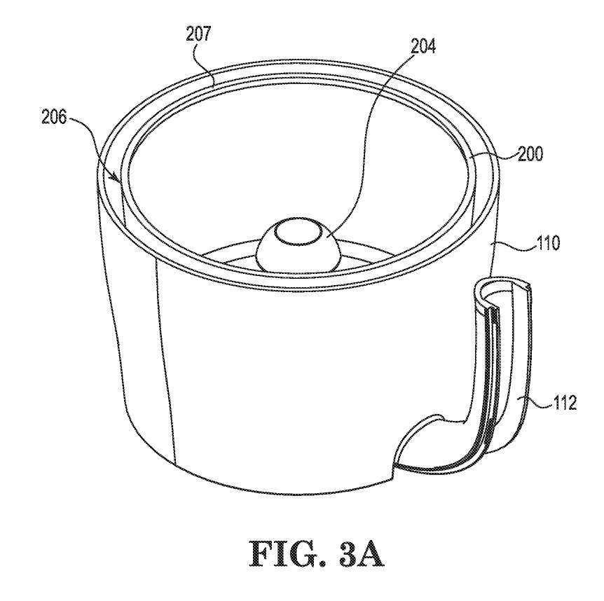

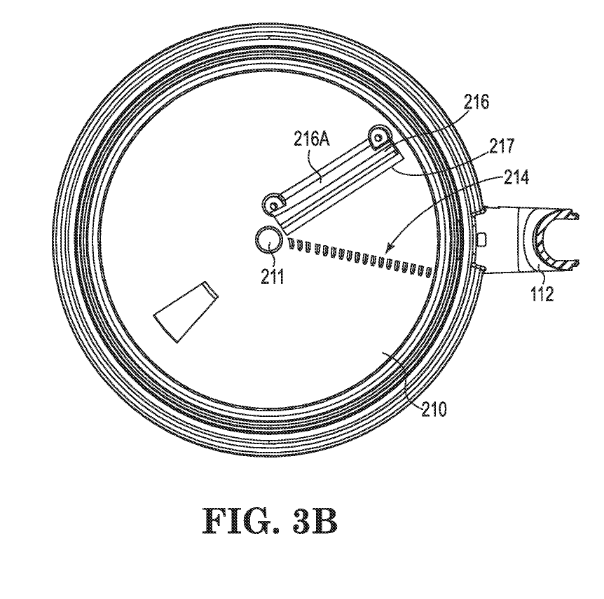

With reference to FIGS. 2C and 3A-3B, in this example embodiment, lid surface 212 of blade-integrated lid 210 further includes a plurality of upwardly or upright protruding members 214 that are disposed adjacent opening 217 and are in close proximity to blade assembly 216. Upwardly protruding members 214, in this example embodiment, are in a substantially straight line however in other embodiments the protruding members can have other configurations and shapes to conform to different types of the food processing the user desires to implement. A longitudinal portion 216A of blade assembly 216 and opening 217 both extend radially from about a center 211 of blade-integrated lid 210 towards an edge of blade-integrated lid 210. In addition, upwardly protruding members 214 extend radially from about center 211 of the blade-integrated lid towards the edge of lid 210. In this example embodiment, surface 212 of blade-integrated lid 210 curves or slopes down from the edges of lid 210 to center 211 such that food cutting assembly 200 simulates a motor driven food processor spiral or helical disc when operating in a standard food processing base. In a related embodiment, blade-integrated lid 210 and blade assembly 216 of food cutting assembly 200 are configured to simulate at least one of a food processor slicing disc, a shredding disc, a grating disc and a dicing disc. In this example embodiment, drive shaft engaging center tube 204A of catch bowl 202 includes cylinder 204B therein that engages with and frictionally fits the drive shaft of the motor to enable catch bowl 202 to rotate within base bowl 110 when the motor in the food processor base is actuated for food processing. In this example embodiment, chute assembly 130 further includes a radial or lateral chute 134 on base bowl lid 120 adjacent center chute 132 to facilitate other types of food processing. In this example embodiment, blade-integrated lid 210 and blade assembly 216 are configured to cut food in various configurations upon receiving food from radial or lateral chute 134 located away from center chute 132.

Referring to FIGS. 3A-3B, there is illustrated partial cross-sectional views of catch bowl 202 and blade-integrated lid 210 with blade assembly 216 inside food processing assembly 100 of FIG. 1 in accordance with an example embodiment of the invention. In this example embodiment, catch bowl 202 is concentrically located within base bowl 110 and is anchored to a drive shaft of the motor via draft shaft engaging member 204A. Sidewalls 206 of catch bowl 202 are spaced apart from the sidewalls of base bowl 110 as well. This configuration facilitates rotation of catch bowl 202 within base bowl 110 when the motor is actuated. Blade-integrated lid 210 is illustrated in more detail in FIG. 3B, which also illustrates the orientation of protruding members 214 with respect to blade assembly 216 and opening 217 that opens into and allows cut food to pass through to catch bowl 202.

In use, food cutting assembly 200, including catch bowl 202 and lid 210, is rotatable relative to base bowl 110 and the lid 120 independent of the drive shaft when in the assembled position. Catch bowl 202 and blade-integrated lid 210 are preferably constructed of molded polymeric or PTFE material and may be constructed of nearly any rigid, structural material that is able to take on the general shape of catch bowl 202 and withstand the normal operating conditions of catch bowl 202. Once catch bowl 202 and lid 210 are placed within the base bowl 110, which is secured via an interlock to the motor base housing via members 116A and 116B, with food cutting assembly 200 being mounted onto the drive shaft and secured by engaging member 204A and sleeve 204B. Lid 120 is then secured to the top of base bowl 110 to fully assemble the food processor 100. Once the food processor is turned on and set to a desired rotational speed so as to begin rotation of food cutting assembly 200, the user can then urge the first foodstuff or vegetable downwardly through chute assembly 130 and towards cutting assembly 200 (and blade-integrated lid 210), with the cutting assembly 200 preferably using a food pusher to do so, so as to begin the processing of the first foodstuff. Upon completion of the processing of the foodstuffs, the user can remove the base lid 120 from base bowl 110 and remove cutting assembly 200 from the base bowl by lifting catch bowl 202 containing the foodstuffs out of base bowl 110. The user can then either remove the foodstuffs from catch bowl 202 or keep the foodstuffs within the catch bowl 202 and use catch bowl 202 as a serving dish with which to serve the foodstuffs.

The foregoing specific embodiments of the present invention as set forth in the specification herein are for illustrative purposes only. Various deviations and modifications may be made within the spirit and scope of the invention without departing from the main theme thereof.

What is claimed is:

1. A food processing assembly comprising:
a base bowl and a lid, the lid further including a chute assembly having a center chute extending from an outer surface of the lid, the base bowl and lid adapted to be located on a motor driven base having a drive shaft extending up from the base and into a center tube in the base bowl;
a catch bowl located concentric and slideably engaged with the base bowl, the catch bowl including a drive shaft engaging center tube protruding upwardly from a catch bowl floor to engage the drive shaft and allow for rotation of the catch bowl relative the base bowl, the catch bowl having generally perpendicular sidewalls extending up from the catch bowl floor and terminating at an upper rim of the catch bowl; and
a blade-integrated lid configured to mate with the catch bowl at the upper rim and to be removably securable to the catch bowl, the blade-integrated lid including a blade assembly on a blade-integrated lid surface and an opening adjacent the blade assembly that is open to an interior of the catch bowl;
wherein the catch bowl and blade-integrated lid operate as a food cutting assembly within the base bowl, as the catch bowl and lid are being rotated at a continuous speed by the drive shaft within the base bowl, to cut food received from the center chute with the blade assembly and direct the cut food into the catch bowl through the opening.

2. The food processing assembly of claim 1 wherein a surface of the blade-integrated lid further includes a plurality of upwardly protruding members adjacent the opening and in close proximity to the blade assembly.

3. The food processing assembly of claim 2 wherein a longitudinal portion of the blade assembly and opening extend radially from about a center of the blade-integrated lid towards an edge of the blade-integrated lid and wherein the plurality of upwardly protruding members extend radially from about the center of the blade-integrated lid towards the catch bowl edge.

4. The food processing assembly of claim 3 wherein the surface of the blade-integrated lid curves down from the catch bowl edge to the center of the lid such that the food cutting assembly simulates a motor driven food processor spiral or helical disc.

5. The food processing assembly of claim 1 wherein the blade-integrated lid and the blade assembly of the food cutting assembly are configured to simulate at least one of a food processor slicing disc, a shredding disc, a grating disc and a dicing disc.

6. The food processing assembly of claim 1 wherein the drive shaft engaging center tube of the catch bowl includes a cylinder therein that engages with and frictionally fits the drive shaft of the motor to enable the catch bowl to rotate within the base bowl when the motor is actuated.

7. The food processing assembly of claim 1 wherein an outer edge of the blade-integrated lid includes a loop handle attached thereto that facilitates securing the blade-integrated lid to the catch bowl and assists in lifting the food cutting assembly from the base bowl.

8. The food processing assembly of claim 5 wherein the chute assembly includes a lateral chute on the base bowl lid adjacent the center chute to facilitate other types of food processing.

9. The food processing assembly of claim 1 wherein a surface of the blade-integrated lid includes a handle attached thereto that facilitates securing the blade-integrated lid to the catch bowl and assists in lifting the food cutting assembly from the base bowl.

10. The food processing assembly of claim 1 wherein the blade assembly and the blade-integrated lid are configured to crush ice and deposit same in the catch bowl.

11. A food cutting assembly adapted for use with a food processing apparatus having a base bowl, a lid and a center chute extending from an outer surface of the lid and a motor driven drive shaft, the food cutting assembly comprising:
a catch bowl configured to be concentric and slideably engaged with the base bowl, the catch bowl including a drive shaft engaging center tube protruding upwardly from a catch bowl floor to engage the drive shaft and allow for rotation of the catch bowl relative the base bowl, the catch bowl having generally perpendicular sidewalls extending up from the catch bowl floor and terminating at an upper rim of the catch bowl; and
a blade-integrated lid configured to mate with the catch bowl at the upper rim and to be removably securable to the catch bowl, the blade-integrated lid including a blade assembly on a blade-integrated lid surface and an opening adjacent the blade assembly that is open to an interior of the catch bowl;
wherein the catch bowl and blade-integrated lid cut food received from the center chute with the blade assembly and direct the cut food into the catch bowl through the opening as the catch bowl and lid are being rotated at a continuous speed by the drive shaft.

12. The food cutting assembly of claim 11 wherein a surface of the blade-integrated lid further includes a plurality of upwardly protruding members adjacent the opening and in close proximity to the blade assembly.

13. The food cutting assembly of claim 12 wherein a longitudinal portion of the blade assembly and opening extend radially from about a center of the blade-integrated lid towards an edge of the blade-integrated lid and wherein the plurality of upwardly protruding members extend radially from about the center of the blade-integrated lid towards the catch bowl edge.

14. The food cutting assembly of claim 13 wherein the surface of the blade-integrated lid curves down from the catch bowl edge to the center of the lid such that the food cutting assembly simulates a motor driven food processor spiral or helical disc.

15. The food cutting assembly of claim 11 wherein the blade-integrated lid and the blade assembly are configured to simulate at least one of a food processor slicing disc, a shredding disc, a grating disc and a dicing disc.

16. The food cutting assembly of claim 11 wherein the drive shaft engaging center tube of the catch bowl includes a cylinder therein that engages with and frictionally fits the drive shaft of the motor to enable the catch bowl to rotate within the base bowl when the motor is actuated.

17. The food cutting assembly of claim 11 wherein an outer edge of the blade-integrated lid includes a loop handle attached thereto that facilitates securing the blade-integrated lid to the catch bowl and assists in lifting the catch bowl from the base bowl.

18. The food cutting assembly of claim 11 wherein the blade-integrated lid and the blade assembly are configured to cut food in various configurations upon receiving food from a lateral chute located away from the center chute.

19. The food cutting assembly of claim 11 wherein a surface of the blade-integrated lid includes a handle attached thereto that facilitates securing the blade-integrated lid to the catch bowl and assists in lifting the food cutting assembly from the base bowl.

20. The food cutting assembly of claim 11 wherein the blade assembly and the blade-integrated lid are configured to crush ice and deposit same in the catch bowl.
